(19) United States
(12) Patent Application Publication
(10) Pub. No.: US 2002/0187424 A1
(43) Pub. Date: Dec. 12, 2002

(54) Optical information recording medium

(76) Inventors: Kenichi Nagata, Hyogo (JP); Hideo Kusada, Osaka (JP); Hiroyuki Ohta, Osaka (JP)

Correspondence Address: Neil A. DuChez, Renner, Otto, Boisselle, & Sklar, L.L.P., 19th Floor, 1621 Euclid Avenue, Cleveland, OH, 44115, US

(21) Appl. No.: 10/118,450

(22) Filed: Apr. 8, 2002

(30) Foreign Application Priority Data
Apr. 12, 2001 (JP) 2001-113669

(51) Int. Cl. G11B 7/24

(52) U.S. Cl. 430/270.13; 369/275.2; 369/275.4; 430/945; 428/64.5

(57) ABSTRACT

An optical information recording medium includes a substrate for allowing laser light to be transmitted therethrough; a first protective layer for protecting the substrate: a recording layer for allowing information to be recorded thereon by laser light irradiation; a second protective layer for protecting the recording layer: an absorption layer for absorbing heat generated by the laser light, and a reflective layer for reflecting the laser light. The first protective layer is formed of a material having a refractive index n₁ satisfying:

n₁≦n_{sub}<2.0

when a material satisfying:

n_{sub}<2.0≦n₁2.4, and

0.85×λ/(2×n₁):d₁≦1.0×λ/(2×n₁)

is applicable to the first protective layer, where n_{sub} is a refractive index of the substrate, d₁(dm) is the thickness of the first protective layer, and λ (nm) is the wavelength of the laser light.

### BACKGROUND OF THE INVENTION

1. Field of the Invention

The present invention relates to an optical information recording medium, and in particular, to an optical information recording medium for causing a reversible phase change between a crystalline phase and an amorphous phase as a result of a temperature rise due to irradiation of laser light, so as to realize recording of a large capacity of information.

2. Description of the Related Art

Optical information recording media (optical discs), including a recording medium formed of a phase change material which causes a phase change between a crystalline phase and an amorphous change as a result of a temperature rise due to irradiation of laser light, are known. One known example of such an optical disc is a DVD-RAM medium realizing a large recording capacity of 4.7 GB on each of two sides, i.e., a total of 9.4 GB on both sides (hereinafter, referred to as a “4.7 GB DVD-RAM”). A 4.7 GB DVD-RAM has a diameter of 120 mm. For recording information on or for reproducing information from a 4.7 GB DVD-RAM, laser light having a wavelength of 660 nm is used. A standard data transfer rate for the 4.7 GB DVD-RAM is 22 Mbps. Examples of main technologies used for 4.7 GB DVD-RAMs will be described below.

1. L & G (Land and Groove) recording system (see, for example, Jpn. J. Appl. Phys., 32 (1993), page 5324). The L & G recording system, by which information is recorded in grooves formed on a substrate surface of an optical disc and on inter-groove regions (i.e., lands), Is used to record a large capacity of information on the optical disc. In order to realize L & G recording on phase change optical discs, the phase difference between light reflected by an area of a recording layer in an amorphous state of an optical disc and light reflected by an area of the recording layer in a crystalline state of the optical disc needs to be sufficiently small.

2. Thermally balanced structure technology (see, for example, Int. Conf. Advanced Materials (1993) 2/B, Information Storage Materials, Tokyo (1994), page 1035). A thermally balanced structure is considered in order to reduce a probability of erroneous over writing of information (i.e., in order to improve post-overwrite reproduction jitter). Specifically, according to the thermally balanced structure of 4.7 GB DVD-RAMs, the light absorptance Aa of an area of a recording layer in an amorphous state and the light absorptance Ac of an area of the recording layer in a crystalline state have the relationship of Ac>Aa.

3. High speed crystalline recording materials (see, for example, J. Appl. Phys., 69 (1999), page 2849). High speed crystalline recording materials are used to record information on an optical disc or to reproduce information recorded on an optical disc at a high speed.

4. Interface layer (see, for example, Jpn. J. Appl. Phys., 37, 2104 (1998)). An interface layer is provided adjacent to the recording layer in order to guarantee a superb recording/reproduction cycle characteristic.

There are five optical characteristics listed below to satisfy In designing an optical disc including a recording layer formed of a phase change material.

(1) The difference between the reflectance of an area of the recording layer in an amorphous state and the reflectance of an area of the recording layer in a crystalline state is as large as possible. (This is necessary to increase the amplitude.)

(2) The light absorptance Aa of an area of the recording layer In an amorphous state and the light absorptance Ac of an area of the recording layer in a crystalline state have the relationship of Aa<Ac, and preferably Ac/Aa >1.2. (This is based on the thermally balanced structure described above.)

(3) The phased difference between the light reflected by an area of the recording layer in an amorphous state and the light reflected by an area of the recording layer in a crystalline state should be sufficiently small. Preferably, the absolute value of the phase difference is equal to or less than 0.05 π. (This is based on the L & G recording system described above.)

(4) The average value of the light absorptance Aa of an area of the recording layer in an amorphous state and the light absorptance Ac of an area of the recording layer in a crystalline state is as large as possible. (This is necessary to increase the recording sensitivity.)

(5) Superb cycle (recording/erasing) characteristic.

The present Inventors have previously developed an optical disc which satisfies the optical characteristics (1) through (5) using technologies 1 through 4. This conventional optical disc includes a polycarbonate substrate, a first protective layer (substrate-side protective layer) provided on the polycarbonate substrate, a first interface layer provided on the first protective layer, a recording layer provided on the Interface layer, a second interface layer provided on the recording layer, a second protective layer (reflective layer-side protective layer) provided on the second interface layer, and a metal reflective layer provided on the second protective layer. For forming each layer, a sheet-type sputtering apparatus is used.

The polycarbonate substrate has a diameter of 120 mm and a thickness of 0.6 mm. On the polycarbonate substrate, a track having a pitch of 0.615 μm is provided. The first protective layer and the second protective layer each include ZnS-SiO₂. The first protective layer has a thickness of about 150 nm, and the second protective layer has a thickness of about 40 nm. Where the refractive index of the first protective layer is n₁, the refractive index of the second protective layer is n₂, and the refractive index of the substrate is n_{sub}, n₁, n₂ and n_{sub} have the relationships of n_{sub}<2.0≦n₁≦2.4 and n_{sub}<2.0≦n₂≦2.4. The first interface layer and the second Interface layer each include a nitride and have a thickness of several nanometers (for example, in the range of 3 nm or greater and 10 nm or less). The recording layer includes Ge, Sb and Te as main components, and has a thickness of about 9 to 10 nm. The metal reflective layer Includes Al or Ag as a main component, and has a thickness of about 100 nm. The first interface layer and the second interface layer may be omitted. An optical disc without the first and second interface layers has m significantly deteriorated recording/reproduction cycle but satisfies the other required characteristics, and thus is still usable as an optical disc. Such an optical disc developed by the present inventors satisfies the 4.7 GB DVD-RAM Standards.

A layer forming takt (I.e., a time period required for forming layers) of the layer forming process of the optical disc (4.7 GB DVD-RAM) usually relies on the layer forming takt of the first protective layer(substrate-side protective layer). The reason is because the first protective layer is thickest and lowest in the sputtering rate among all the layers due to the material thereof. However, ZnS-SiO₂ used for forming the first protective layer is known as having a relatively high sputtering rate among materials which can be used for a protective layer. In order to improve the productivity of the optical disc, it is necessary to shorten the layer forming takt of the layers of the optical disc, especially the layer forming takt of the first protective layer. However, when the sputtering power is made too large in order to reduce the layer forming takt of the first protective layer, the substrate temperature is excessively increased, which causes deformation. One technique for shortening the layer forming takt of the first protective layer is to increase the number of layer forming chambers so that the first protective layer is formed in a plurality of steps. However, a layer forming apparatus realizing such a technique is expensive.

### SUMMARY OF THE INVENTION

According to one aspect of the invention, an optical information recording medium includes a substrate for allowing laser light to be transmitted therethrough; a first protective layer provided on the substrate for protecting the substrate; a recording layer provided on the first protective layer for causing a reversible phase change between a crystalline phase and an amorphous phase as a result of a temperature rise due to irradiation of the laser light so as to allow information to be recorded thereon; a second protective layer provided on the recording layer for protecting the recording layer; an absorption layer provided on the second protective layer for absorbing heat generated by the laser light; and a reflective layer provided on the absorption layer for reflecting the laser light. The first protective layer is formed of a material having a refractive index satisfying:

n₁≦n_{sub}<2.0

when a material satisfying the following expressions is applicable to the first protective layer:

n_{sub}<2.0≦n₁≦2.4, and

0.85×λ/(2×n₁)≦d₁≦1.0×λ/(2×n₁)

where n_{sub} is the refractive index of the substrate, n, is the refractive index of the first protective layer, d₁ is the thickness of the first protective layer in nanometer, and λ is the wavelength of the laser light in nanometer.

In one embodiment of the invention, the wavelength λ of the laser light is 660 nm. The substrate is formed of polycarbonate. The recording layer includes Ge, Sb and Te, and has a thickness d_{rec} (nm) of 7≦d_{rec}≦10. The second protective layer has a thickness d₂ (nm) of 20≦d₂≦60. The absorption layer includes Ge and Cr or includes Si and has a thickness d_{ab} (nm) of 30≦d_{ab}≦60. The reflective layer includes a metal element selected from the group consisting of Au, Cu, Cr, Al and Ag, and has a thickness d_{ref} (nm) of 50≦d_{ref}≦150.

In one embodiment of the invention, the optical information recording medium further includes an interface layer provided at a position corresponding to at least one of a position between the first protective layer and the recording layer and a position between the recording layer and the second protective layer. The interface layer includes a material selected from the group consisting of nitrides, nitride oxides, carbides and mixtures thereof, and has a thickness dᵢₙₜ (nm) of 3≦dᵢₙₜ≦10.

In one embodiment of the invention, the wavelength λ of the laser light is 660 nm. The refractive index n₁ of the first protective layer 1.4≦n₁≦1.6. The thickness d₁ (nm) of the first protective layer is 10≦d₁40.

In one embodiment of the invention, the first protective layer Includes a silicon oxide or an aluminum oxide.

According to another aspect of the invention, an optical information recording medium includes a substrate for allowing laser light to be transmitted therethrough; a first protective layer provided on the substrate for protecting the substrate; a recording layer provided on the first protective layer for causing a reversible phase change between a crystalline phase and an amorphous phase as a result of a temperature rise due to irradiation of the laser light so as to allow information to be recorded thereon,: a second protective layer provided on the recording layer for protecting the recording layer, an absorption layer provided on the second protective layer for absorbing heat generated by the laser light; and a reflective layer provided on the absorption layer for reflecting the laser light. A refractive index n_{sub} of the substrate and a refractive index n₁ of the first protective layer have the relationship of:

n₁≦n_{sub}.

Thus, the invention described herein makes possible the advantages of providing (1) a low-cost optical information recording medium having superb characteristics which can be produced within a short layer forming takt; and (2) a 4.7 GB DVD-RAM satisfying the 4.7 GB DVD-RAM Standards which can be produced within a short layer forming takt.

These and other advantages of the present invention will become apparent to those skilled in the art upon reading and understanding the following detailed description with reference to the accompanying figures.

### BRIEF DESCRIPTION OF THE DRAWINGS

FIG. 1 is a cross-sectional view of an optical information recording medium (optical disc) according to the present invention;

FIG. 2 shows a structure of a sheet-type layer forming apparatus; and

FIG. 3 shows a structure of a recording/reproduction apparatus for recording information on or reproducing information from an optical disc according to the present invention.

### DESCRIPTION OF THE PREFERRED EMBODIMENTS

Hereinafter, the present invention will be described by way of illustrative examples with reference to the accompanying drawings.

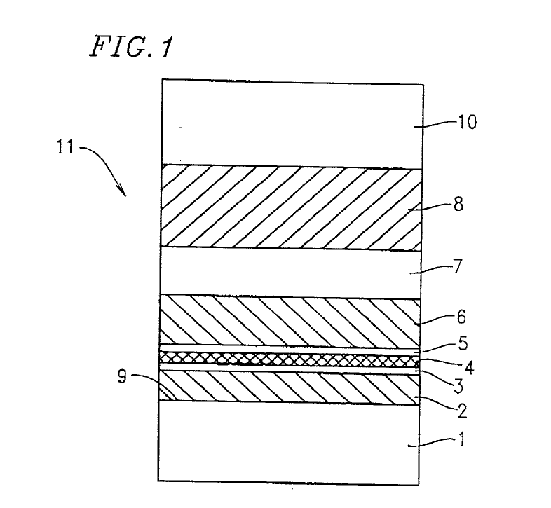

FIG. 1 is a cross-sectional view of an optical information recording medium (optical disc) 11 according to an example of the present invention.

The optical disc 11 includes a substrate 1, a first protective layer (substrate-side protective layer) 2 provided on the substrate 1, a first interface layer 3 provided on the first protective layer 2, a recording layer 4 provided on the first interface layer 3, a second Interface layer 5 provided on the recording layer 4, a second protective layer 6 provided on the second interface layer 5, an absorption layer 7 provided on the second protective layer 6, a reflective layer 8 provided on the absorption layer 7, and a protective substrate 10 provided on the reflective layer 8. The optical disc 11 is different from the above-described conventional optical disc in the material of the first protective layer 2.

The substrate 1 may be a resin plate formed of a material transmissive to laser Sight, such as, for example, polycarbonate. The substrate 1 has a continuous spiral groove (also referred to as aL “guide groove” or a “track”) on a surface 9 thereof. Laser light used for recording information on the optical disc 11 and/or reproducing Information recorded on the optical disc 11 is incident on the side of the substrate 1. In this specification, laser light having a wavelength λ of about 660 nm Is used.

The first protective layer 2 Is used to protect the substrate 1 from the heat generated by the laser light (i.e., to provide a heat insulation effect). The first protective layer 2 is also provided to control the temperature rise/fall characteristic of the recording layer 4. The temperature rise/fall characteristic of the recording layer 4 can be controlled by the thermal conductivity characteristic of the first protective layer 2. Where the refractive index of the first protective layer 2 is n₁ and the refractive index of the substrate 1 is n_{sub}, n₁≦n_{sub}. In the case where the first protective layer 2 is formed of polycarbonate, the refractive index n₁ of the first protective layer 2 is 1.4 ≦n_{1≦}1.6 (when λ=660 nm). The first protective layer 2 is formed of a material which is physically and chemically stable. Namely, the first protective layer 2 is formed of a material having a melting point and a softening point which is higher than the melting point of a material of the recording layer 4. This prevents generation of solid solubilization between the recording layer 4 and the first protective layer 2. The first protective layer 2 is preferably formed of a dielectric material such as, for example, Al₂O₃ or SiOₓ or a material containing such a dielectric material as a main component. The first protective layer 2 preferably has a thickness d₁ equal to or less than 75 nm, more preferably equal to or less than 50 nm, and most preferably 10 nm ≦d₁≦40 nm. The range of the thickness of the first protective layer 2 will be described below in detail.

The second protective layer 6 is used to protect the recording layer 4 from the heat generated by the laser light (I.e., to provide a heat insulation effect). The second protective layer 6 is also provided to control the temperature rise/fall characteristic of the recording layer 4 like the first protective layer 2. The temperature rise/fall characteristic of the recording layer 4 can be controlled by the thermal conductivity characteristic of the second protective layer 6. Where the refractive index of the second protective layer 6 is n₂ and the refractive index of the substrate 1 is n_{sub}, n₂>n_{sub}. The refractive index n₂ of the second protective layer 6 is preferably 2.0≦n₂≦2.4 (when λ-660 nm). The second protective layer 6 is formed of a material which is physically and chemically stable. Namely, the second protective layer 6 is formed of a material having a melting point and a softening point which is higher than the melting point of a material of the recording layer 4. This prevents generation of solid solubilization between the recording layer 4 and the second protective layer 6. The second protective layer 6 Is preferably formed of a dielectric material such as, for example, ZnS, Ta₂O₅, or Y₂O₅ or a material containing such a dielectric material as a main component. The second protective layer 6 preferably has a thickness of 40 nm±20 nm, and more preferably 40 nm ±10 nm.

The recording layer 4 is formed of a material which causes a reversible phase change between a crystalline phase and an amorphous phase as a result of a temperature rise when irradiated with laser light. The recording layer 4 is formed of a material which contains, for example, Te, Sb and Ge as main components, and is represented by GeₓSb_{y}Te_{z} (0.10≦x ≦0.40, 0.05≦y≦0.25, 0.45≦z≦0.65, x+y +z −l). A preferable material of the recording layer 4 is a quaternary system material Te-Sb-Ge-Sn containing Sn at 4% or greater and 10% or less. A thickness d_{rec} of the recording layer 4 is 7 nm≦d_{rec}≦10 nm. When the recording layer 4 is too thin, the light reflected by the reflective layer 8 cannot be detected in the recording layer 4. When the recording layer 8 is too thick, a superb recording/reproduction cycle characteristic satisfying the 4.7 GB DVD-RAM Standards cannot be obtained.

The first interface layer 3 is provided in order to prevent the elements contained in the recording layer 4 and the elements contained in the first protective layer 2 from being diffused to each other. The second interface layer 5 is provided in order to prevent the elements contained in the recording layer 4 and the elements contained in the second protective layer 6 from being diffused to each other. Provision of the first interface layer 3 and the second Interface layer 5 improve the recording/reproduction cycle (see, for example, Japanese Laid-Open Publication No. 4-52188). The first and second interface layers 3 and 5 are each formed of a material which is selected from the group consisting of nitrides represented by general formula X—N, nitride oxides represented by general formula X—O—N, carbides represented by general formula Y—C, and mixtures thereof. Here, X contains at least one element selected from the group consisting of Ge, Cr, Sl, Al and Te. Y may be Si. A material of the first and second interface layers 3 and 5 has an absorption coefficient which is sufficiently small with respect to the laser light used for recording, and preferably is equal to or less than 0.2. A thickness dᵢₙₜ₃ of the first interface layer 3 and a thickness dᵢₙₜ₅ of the second interface layer 5 are sufficiently small. The thickness d_{int3,5} is preferably 3 nm≦d_{int3,5}≦20 nm, and is more preferably 3 nm≦d_{int3,5}≦10 nm. The improvement in the recording/reproduction cycle characteristic provided by the first and second interface layers 3 and 5 is especially noticeable when the recording layer 4 is relatively thin (for example, d_{rec}≦15 nm). The first interface 3 and the second interface 5 may be omitted, or one of the first and second interfaces 3 and 5 may be provided, as long as the optical disc is usable as a 4.7 GB DVD-RAM although the recording/reproduction cycle characteristic is deteriorated.

The absorption layer 7 is provided in order to correct the light absorptance of the recording layer 4. The absorption layer 7 is formed of a material capable of absorbing light used for recording information. The absorption layer 7 is formed of, for example, a material containing Ge and Cr as main components, or a material containing Si as a main component. Provision of the absorption layer 7 between the second protective layer 6 and the reflective layer 8 adjusts the phase difference between light reflected by an area of recording layer 4 in a crystalline state and light reflected by an area of the recording layer 4 in an amorphous state. Thus, optical characteristic (5) described above is satisfied. A refractive index n_{ab} of the absorption layer 7 is 2≦n_{ab}≦5, and an annihilation coefficient k is 1.5 5≦k≦4.5.

Provision of the second protective layer 6 and the absorption layer 7 can restrict the cross-erasure occurring when information is recorded on a track adjacent to a track which already has information recorded thereon (i.e., the probability at which information which has already been recorded is erased by recording information on an adjacent track) within a practical range. When the recording layer 4 is irradiated with laser light having a high power for recording information, the recording layer 4 and also the absorption layer 7 generate heat. The heat generation in the absorption layer 7 promotes the temperature rise of the recording layer 4. As a result, high sensitivity recording on the optical disc 11 is realized. Immediately after the irradiation of the recording layer 4 with the laser light, the heat generated In the absorption layer 7 starts to be diffused toward the reflective layer 8 formed of a material having a high thermal conductivity. This minimizes thermal diffusion in the planar direction of the recording layer 4 (i.e., the horizontal direction to the sheet of FIG. 1). When the absorption layer 7 is too thin, sufficient heat cannot be generated In the absorption layer 7. When the absorption layer 7 is too thick, a sufficient amount of heat cannot escape from the absorption layer 7 toward the reflective layer 8 when the recording layer 4 is cooled. Accordingly, a thickness d_{ab} of the absorption layer 7 is preferably 30 nm≦d_{ab}≦60 nm.

The reflective layer 8 is provided in order to allow the heat generated In the absorption layer 7 to escape as described above. The reflective layer 8 is formed of a material containing, as a main component, a metal element selected from the group consisting of Au, Cu, Cr, Al and Ag. The reflective layer 8 is preferably formed of Ag or Al, which has a high thermal conductivity and is relatively low-cost. A thickness d_{ref} of the reflective layer 8 is preferably 50 nm≦d_{ref}<150 nm. The optical disc characteristics do not change even when d_{ref}≦150 nm.

The protective ssubstrate 10 (is formed of a resin plate similar to the substrate 1 The protective substrate 10 is bonded on the reflective layer 8 using an adhesive resin. Although not shown, two optical discs may be bonded together using an adhesive resin. In this case, information can be recorded on both side of the resultant optical disc, and information recorded on both side of the resultant optical disc can be reproduced.

The first protective layer 2 is formed of a material satisfying n₁≦n_{sub}. It should be noted that under certain conditions, the optical characteristics remain substantially the same even when the first protective layer 2 is formed of a material having a refractive index n, satisfying the relationship of n₁≦n_{sub}<2.0 instead of a material having a refractive index n₁ satisfying the relationship of n_{sub}≦2.0≦n₁≦2.4 used in the conventional optical disc. The certain conditions are;

0.85×λ/(2×n₁)≦d₁≦1.0×λ/(2×n₁),

where λ (wavelength of the laser light) is about 660 nm.

This means that the material of the first protective layer of the conventional optical disc may be replaced with the material of the first protective layer 2 according to the present invention, with the optical characteristics remaining substantially the same. The other layers may be formed of the same materials as those of the conventional optical disc, each with an equivalent range of thickness to that of the conventional optical disc. The present inventors found the above by performing optical simulation regarding various structures of optical discs. As described above, the first protective layer of the conventional optical disc has a thickness of about 150 nm, which satisfies the above-mentioned condition regarding d₁.

The present inventors also found the following: in the case where the refractive index n, of the material of the first protective layer 2 and the refractive index n_{sub} of the material of the substrate 1 are close to each other, there is little dependency of the optical characteristics on the thickness d₁ of the first protective layer 2. However, when the first protective layer 2 is too thin, the heat insulation effect provided by the first protective layer 2 is reduced, which significantly deteriorates a recording repetition characteristic of the optical disc. Therefore, the first protective layer 2 needs to have a thickness d₁ equal to or greater than 10 nm. The recording repetition characteristic of the optical disc Is improved as the thickness d₁ of the first protective layer 2 increases, but the degree of improvement is small when d₁≧50 nm.

When the first protective layer 2 is too thick, the layer forming takt of the layers of the optical disc 11 cannot be shortened. The layer forming rate of oxide-based materials usable for the first protective layer 2 according to the present invention (for example, Al₂O₃ and SiO₂) is low and is ½ or less of the layer forming rate of ZnS-based materials usable for the first protective layer of the conventional optical disc (for example, ZnS-SiO₂). The layer forming rate of the ZnS-based materials Is lower than the layer forming rate of the other layers of the optical discs, but is known as being higher among the layer forming rates of materials generally usable for a protective layer. In consideration of this, in order to shorten the layer forming takt, the thickness d₁ of the first protective layer 2 needs to be ½ or less of the thickness of the first protective layer of the conventional optical disc. Since the thickness of the first protective layer of the conventional optical disc is about 150 nm, the thickness d₁ of the first protective layer 2 needs to be equal to or less than 75 nm, and is more preferably equal to or less than 50 nm.

The optical disc 11 shown in FIG. 1 having the above-described structure satisfies optical disc characteristics (1) through (5) and has substantially the same optical characteristics (for example, the reflectance, light absorptance of the recording layer 4 and the absorption layer 8) as those of the conventional optical disc. The thickness of the first protective layer 2 can be reduced to about 1/10 of the thickness of the first protective layer of the conventional optical disc. The first protective layer 2, formed of a material according to the present invention instead of the material used for the conventional optical disc, can be formed in a shorter takt. Accordingly, the present invention provides an optical disc which can be produced In a shorter tact without changing the structure of the layer forming apparatus, and thus Improves the productivity of the optical disc.

Hereinafter, specific examples of the present invention will be described with the experimental results Three optical disc samples 1 through 3 were produced with the following layers stacked as described above and formed of the following materials. The substrate 1 was formed of polycarbonate. The first interface layer 3 was formed of Ge₇₀N₃₀. The recording layer 4 was formed of Ge₃₀Sb₁₃Te₅₂Sn₅. The second interface layer 5 was formed of Ge₇₀N₃₀. The second protective layer 6 was formed of Zns-20 mol % SiO₂. The absorption layer 7 was formed of Ge₇₀Cr₃₀. The reflective layer 8 was formed of Al. In sample 1 produced in accordance with the prior art, the first protective layer 2 was formed of ZnS-20 mol % SiO₂. In samples 2 and 3, produced according to the present invention, the first protective layer 2 of each sample were respectively formed of Sio₂ and Al₂O₃Samples 1 through 3 are summarized in Table 1. Although sample 1 was produced according to the prior art, the reference numerals in the present invention will be used for convenience.

TABLE 1

| | Sample 1 | | Sample 2 | | Sample 3 | |
|---|---|---|---|---|---|---|
| | Material | Thickness (nm) | Material | Thickness (nm) | Material | Thickness (nm) |
| Substrate | Polycarbonate | | Polycarbonate | | Polycarbonate | |
| 1st protective | ZnS-20 mol % SiO₂ | 150 | SiO₂ (n₁ = 1.5) | 40 | Al₂O₃ (n₁ = 1.5) | 40 |
| layer 2 | (2.0 ≦ n₁ ≦ 2.4) | | | | | |
| Interface layer | Ge₇₀ N₃₀ | 5 | Ge₇₀ N₃₀ | 5 | Ge₇₀ N₃₀ | 5 |
| 3,5 | | | | | | |
| Recording layer 4 | Ge₃₀Sb₁₃Te₅₂Sn₅ | 9 | Ge₃₀Sb₁₃Te₅₂Sn₅ | 9 | Ge₃₀Sb₁₃Te₅₂Sn₅ | 9 |
| 2nd protective | ZnS-20 mol % SiO₂ | 40 | ZnS-20 mol % SiO₂ | 40 | ZnS-20 mol % SiO₂ | 40 |
| layer 6 | | | | | | |
| Absorption layer 7 | Ge₇₀Cr₃₀ | 40 | Ge₇₀Cr₃₀ | 40 | Ge₇₀Cr₃₀ | 40 |
| Reflective layer 8 | Al | 100 | Al | 100 | Al | 100 |

The substrate 1 had a guide groove of the 4.7 GB DVD-RAM format Including convexed and concaved portions having a pitch of 1.2 μm and a depth of 70 nm. The substrate 1 had a diameter of 120 mm and a thickness of 0.6 mm.

As shown in Table 1, all the layers were formed to have the same thickness in samples 1 through 3, except for the first protective layer 2.

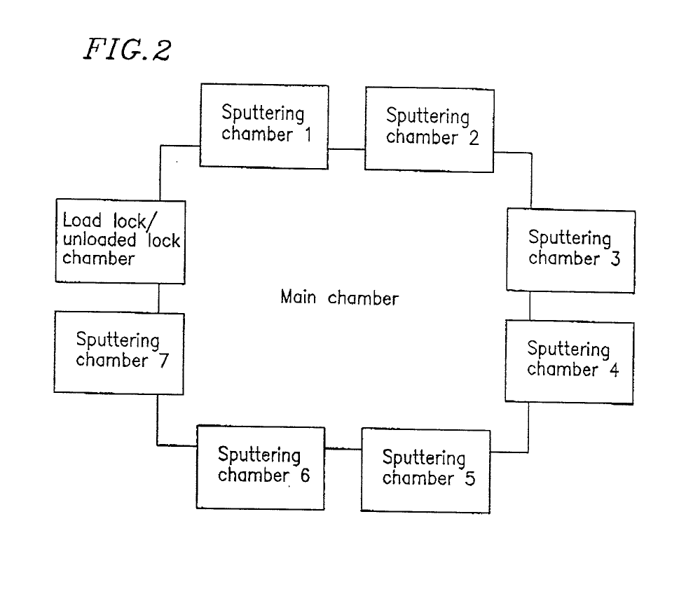

FIG. 2 shows a structure of a sheet-type layer forming apparatus including a main chamber, seven sputtering chambers, and a load lock/unload lock chamber. The Layers of the optical disc samples 1 through 3 were formed using the sheet-type layer formatting apparatus shown in FIG. 2 by a magnetron sputtering method. Sputtering chamber 1 accommodates a target for the material for the first protective layer 2. Sputtering chamber 2 accommodates a target for the material for the first interface layer 3. Sputtering chamber 3 accommodates a target for the material for the recording layer 4. Sputtering chamber 4 accommodates a target for the material for the second interface layer 5. Sputtering chamber 5 accommodates a target for the material for the second protective layer 6. Sputtering chamber 6 accommodates a target for the material for the absorption layer 7. Sputtering chamber 7 accommodates a target for the material for the reflective layer 8.

The substrate 1 Is put into the main chamber through the load lock/unload lock chamber, and sequentially receives the materials sputtered from sputtering chambers 1 through 7 sequentially. When sputtering from sputtering chamber 7 is finished, the optical disc is completed. The completed optical disc is removed from the main chamber through the load lock/unload lock chamber. Using the sheet-type layer forming apparatus shown in FIG. 2, sputtering is performed in a pipelined manner where seven chambers sputter to seven substrates 1 simnultaneously. Therefore, when the layer forming takt is the same among the seven sputtering chambers and short, the optical disc productivity is improved.

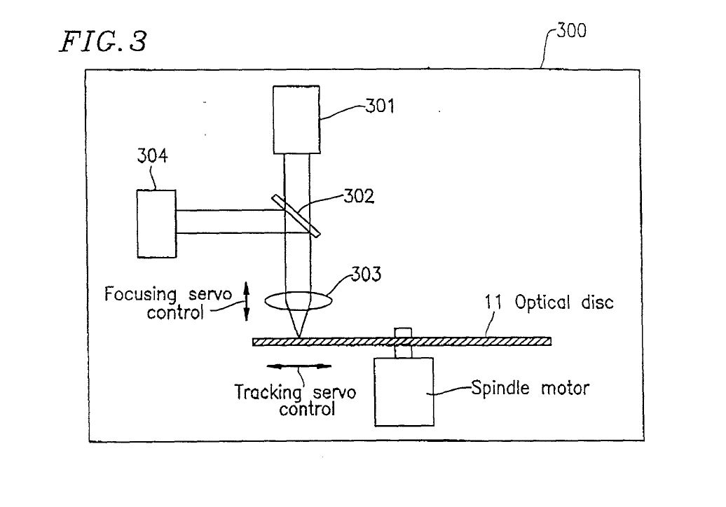

Although the layers of the optical disc 11 are produced by a sputtering method in this example, the present invention is not limited to this. The optical disc 11 according to the present invention may be produced using, for example, electron beam evaporation, ion plating or CVD. FIG. 3 shows a structure of a recording/reproduction apparatus 300 for recording information on or reproducing information from an optical disc 11 according to the present invention.

With reference to FIG. 3, an operation for recording information on the optical disc 11 according to the present invention will be described. For recording information on the optical disc 11, a semiconductor laser device 301 provided as an irradiation light source emits light which is demodulated in accordance with the information to be recorded. The light emitted by the semniconductor laser device 301 is transmitted through a half mirror 302, an objective lens 303 and the substrate 1, and then forms a light spot (recording mark) on the recording layer 4. The state of an area of the recording layer 4 where the light spot is formed is changed in accordance with the information (for example, a crystalline state is changed into an amorphous state, or vice versa). In this manner, the information is recorded in the form of a change in the state of the recording layer 4

With reference to FIG. 3, an operation for reproducing information on an optical disc 11 according to the present invention will be described. For reproducing information on the optical disc 11, the semiconductor laser device 301 emits light which is not demodulated. The light emitted by the semiconductor laser device 301 is transmitted through the half mirror 302, the objective lens 303 and the substrate 1, and then forms a light spot on the recording layer 4. The light is then reflected by the recording layer 4 at a reflectance which relies on the state of the area of the recording layer 4 where the light spot Is formed. The light reflected by the recording layer 4 is transmitted through the substrate 1 and the objective lens 303, and then reaches the half mirror 302. The light is reflected by the halfmirror 302 at 90 degrees and is incident on a photodetector 304. The photodetector 304 removes, from the light, an information signal representing the information recorded on the optical disc 11 and a servo signal used for tracking.

The recording layer 4 of each of optical disc samples 1 through 3 was crystallized by a laser initialization apparatus (not shown), and optical disc samples 1 through 3 were tested for their cycle (recording/reproduction) characteristics using the recording/reproduction apparatus 300 shown in FIG. 3. Information was recorded on a guide groove (groove) and an inter-groove region (land) of each of optical disc samples 1 through 3 as described above, and information recorded on the guide groove (groove) and the inter-groove region (land) was reproduced as described above.

The light emitted by the semiconductor laser device 301 was 660 nm. The objective lens 303 had a numerical aperture (NA) of 0.6. The information was recorded at a linear velocity of 8.2 m/a by a modulation system of 8/16, RLL (2, 10) in accordance with the 4. 7 GB DVD-RAM Standards. The shortest mark length was 0.42 μm. The experimental results are shown in Table 2.

TABLE 2

| | Sample | Sample | Sample |
|---|---|---|---|
| | 1 | 2 | 3 |
| Groove recording sensitivity (mW) | 11.0 | 10.7 | 10.7 |
| Land recording sensitivity (mW) | 11.3 | 11 .1 | 11 .0 |
| Groove reproduction jitter (%) | 8.3 | 8.4 | 8.5 |
| Land reproduction jitter (%) | 8.5 | 8.4 | 8.3 |
| Deterioration of groove | +1.5 | +1.6 | +1.3 |
| reproduction jitter caused by | | | |
| recording information on adjacent | | | |
| lands 1000 times (%) | | | |
| Deterioration of land reproduction | +0.5 | +0.5 | +0.7 |
| jitter caused by recording | | | |
| information on adjacent grooves | | | |
| 1000 times (%) | | | |
| Number of groove cycles when the | >100,000 | 10,000 | 10,000 |
| jitter was deteriorated by 3% | | | |
| Number of land cycles when the | >100,000 | 2,000 | 1,500 |
| jitter was deteriorated by 3% | | | |

As can be appreciated from Table 2, optical disc samples 1 through 3 exhibited substantially the same results except for the cycle characteristics. Samples 2 and 3 according to the present Invention exhibited lower cycle characteristics than sample 1 according to the prior art, but the cycle characteristics of samples 2 and 3 do not present any problem in practical use as long as the optical discs are used for specific uses. The 4.7 GB DVD-RAM Standards do not provide any limitation or restriction regarding the cycle characteristics. It should be noted that the thickness of the first protective layer 2 needs to be at least 10 nm since the cycle characteristic deteriorates as the thickness of the first protective layer 2 is reduced. Information cannot be recorded in repetition on an optical disc in which the first protective layer 2 has a thickness of less than 10 nm.

The experimental results regarding the relationship between the layer forming rate and the optical disc characteristics will be described. The layer forming conditions were the same among optical disc samples 1 through 3 except for the first protective layer 2. In the case of optical disc sample 1 (in which the first protective layer 2 was formed of ZnS-20 mol % SiO₂ as in the prior art), the layer forming takt of the layers relied on the layer forming takt of the first protective layer. When the layer forming rate of the first protective layer is increased (i.e., when the sputtering power is increased or the layer forming temperature is increased), the yield of the optical disc is reduced due to the tilt occurring to the optical disc.

An optical disc tends to be slightly tilted during the layer formation due to the influence of, for example, the layer forming temperature or the sputtering power. When an optical disc having, for example, a radial tilt in a radial direction thereof is mounted on a recording/reproduction apparatus, the distance between the recording head of the recording/reproduction apparatus and the surface of the optical disc varies in the radial direction of the optical disc. Accordingly, when the tilt is excessive, recording of information on the optical disc or reproduction of information from the optical disc may become impossible.

The upper limit of the layer forming rate at which at least 900 out of 1000 optical discs of sample 1 can have a radial tilt of within ±0.5 degrees was obtained. The upper limit was 9seconds. The upper limit obtained regarding each of optical disc samples 2 and 3 was 6 seconds. This indicates that the optical disc according to the present invention can shorten the layer forming takt by about 30%. the present invention provides an optical information recording medium including a substrate for allowing laser light to be transmitted therethrough, a first protective layer provided on the substrate for protecting the substrate; a recording layer provided on the first protective layer for causing a reversible phase change between a crystalline phase and an amorphous phase as a result of a temperature rise due to irradiation of the laser light so as to allow information to be recorded thereon: a second protective layer provided on the recording layer for protecting the recording layer; an absorption layer provided on the second protective layer for absorbing heat generated by the laser light; and a reflective layer provided on the absorption layer for reflecting the laser light. The first protective layer is formed of a material having a refractive index satisfying:

n_{1≦}n_{sub}<2.0

when a material satisfying the following expressions is applicable to the first protective layer:

n_{sub}<2.0≦n₁≦2.4, and

0.85×λ/(2×n₁)≦d₁≦1.0×λ/(2×n₁)

where n_{sub} is the refractive index of the substrate, n₁ is the refractive index of the first protective layer, d₁ is the thickness of the first protective layer in nanometer, and λ is the wavelength of the laser light in nanometer.

Due to such a structure, the thickness of the first protective layer can be reduced. As a result, the layer forming takt of the first protective layer, and thus the layer forming takt of all the layers, is shortened. This improves the productivity.

Various other modifications will be apparent to and can be readily made by those skilled In the art without departing from the scope and spirit of this invention. Accordingly, it is not intended that the scope of the claims appended hereto be limited to the description as set forth herein, but rather that the claims be broadly construed.

What is claimed is:

1. An optical information recording medium, comprising:
a substrate for allowing laser light to be transmitted therethrough
a first protective layer provided on the substrate for protecting the substrate;
a recording layer provided on the first protective layer for causing a reversible phase change between a crystalline phase and an amorphous phase as a result of a temperature rise due to irradiation of the laser light so as to allow information to be recorded thereon;
a second protective layer provided on the recording layer for protecting the recording layer;
an absorption layer provided on the second protective layer for absorbing beat generated by the laser light; and
a reflective layer provided on the absorption layer for reflecting the laser light,
wherein the first protective layer is formed of a material having a refractive index satisfying:
n₁≦n_{sub}<2.0
when a material satisfying the following expressions is applicable to the first protective layer:
n_{sub}<2.0n₁≦2.4, and
0.85×λ/(2×n₁)≦d₁≦1.0×λ/(2×n₁)
where n_{sub} is the refractive index of the substrate, n₁ is the refractive index of the first protective layer, d₁ is the thickness of the first protective layer in nanometer, and λ is the wavelength of the laser light in nanometer.

2. An optical information recording medium according to claim 1, wherein:
the wavelength λ of the laser light is 660 nm,
the substrate is formed of polycarbonate,
the recording layer includes Ge, Sb and Te, and has a thickness d_{rec} (nm) of 7≦d_{rec}≦10,
the second protective layer has a thickness d₂ (nm) of 20≦d₂≦60,
the absorption layer includes Ge and Cr or includes Si and has a thickness d_{ab} (nm) of 30≦d_{ab}≦60, and the reflective layer includes a metal element selected from the group consisting of Au, Cu, Cr. Al and Ag, and has a thickness d_{ref} (nm) of 50≦d_{ref}≦150.

3. An optical information recording medium according to claim 1, further comprising an interface layer provided at a position corresponding to at least one of a position between the first protective layer and the recording layer and a position between the recording layer and the second protective layer,
wherein the interface layer includes a material selected from the group consisting of nitrides, nitride oxides, carbides and mixtures thereof, and has a thickness dᵢₙₜ (nm) of 3≦dᵢₙₜ≦10.

4. An optical information recording medium according to claim 1, wherein:
the wavelength λ of the laser light is 660 nm,
the refractive index n₁ of the first protective layer is 1.4 5≦n₁≦1.6, and
the thickness d₁ (nm) of the first protective layer is 10≦d₁≦40.

5. An optical information recording medium according to claim 1, wherein the first protective layer includes a silicon oxide or an aluminum oxide.

6. An optical information recording medium, comprising:
a substrate for allowing laser light to be transmitted therethrough;
a first protective layer provided on the substrate for protecting the substrate;
a recording layer provided on the first protective layer for causing a reversible phase change between a crystalline phase and an amorphous phase as a result of a temperature rise due to irradiation of the laser light so as to allow information to be recorded thereon;
a second protective layer provided on the recording layer for protecting the recording layer;
an absorption layer provided on the second protective layer for absorbing heat generated by the laser light; and
a reflective layer provided on the absorption layer for reflecting the laser light,
wherein a refractive index n_{sub} of the substrate and a refractive index n₁ of the first protective layer have the relationship of:
n₁≦n_{sub}.
